(19) United States
(12) Patent Application Publication
(10) Pub. No.: US 2024/0319145 A1
(43) Pub. Date: Sep. 26, 2024

(54) ESTIMATION OF ACOUSTIC INSPECTION MEASUREMENT ACCURACY

(71) Applicant: Evident Canada, Inc., Québec (CA)

(72) Inventor: Alain Le Duff, Quebec (CA)

(21) Appl. No.: 18/698,188

(22) PCT Filed: Oct. 18, 2022
(86) PCT No.: PCT/CA2022/051534

§ 371 Date: Apr. 3, 2024

Related U.S. Application Data
(60) Provisional application No. 63/270,768, filed on Oct. 22, 2021.

(51) Int. Cl. G01N 29/44; G01N 29/06; G01N 29/28

(52) U.S. Cl. CPC G01N 29/4418; G01N 29/0645; G01N 29/28; G01N 2291/02854; G01N 2291/0289; G01N 2291/106

(57) ABSTRACT

An acoustic inspection system, such as an ultrasound inspection system, can determine an estimate of an a priori accuracy of a measurement using a determined lower bound on an indicium of dispersion of the measurement, such as a variance, and then display the determined estimate of the a priori accuracy to the user.

### CLAIM OF PRIORITY

This application claims the benefit of priority of U.S. Provisional Patent Application Ser. No. 63/270,768 titled “A PRIORI ESTIMATION OF THE ACCURACY OF MEASUREMENT RESULTS” to Alain Le Duff, filed on Oct. 22, 2021, the entire contents of which being incorporated herein by reference.

### FIELD OF THE DISCLOSURE

This document pertains generally, but not by way of limitation, to non-destructive evaluation, and more particularly, to apparatus and techniques for providing acoustic inspection, such as using ultrasound testing.

### BACKGROUND

Various inspection techniques can be used to image or otherwise analyze structures without damaging such structures. For example, one or more of x-ray inspection, eddy current inspection, or acoustic (e.g., ultrasonic) inspection can be used to obtain data for imaging of features on or within a test specimen. For example, acoustic imaging can be performed using an array of ultrasound transducer elements, such as to image a region of interest within a test specimen. Different imaging modes can be used to present received acoustic signals that have been scattered or reflected by structures on or within the test specimen.

### SUMMARY OF THE DISCLOSURE

Using various techniques of this disclosure, an acoustic inspection system, such as an ultrasound inspection system, can determine an estimate of an a priori accuracy of a measurement using a determined lower bound on an indicium of dispersion of the measurement, such as a variance, and then display the determined estimate of the a priori accuracy to the user.

In an aspect, this disclosure is directed to a computer-implemented method of generating an estimate of an a priori accuracy of a measurement of an acoustic inspection system configured to measure a parameter of an object under test, the computer-implemented method comprising: generating, using a plurality of acoustic parameters, a model representing an acoustic signal to be received by a probe assembly of the acoustic inspection system: determining, using the plurality of acoustic parameters, a lower bound on an indicium of dispersion of the measurement: determining the a priori estimate using the determined lower bound on the indicium of dispersion of the measurement: and displaying, on a display device, the determined a priori estimate of the accuracy of the acoustic inspection system.

In an aspect, this disclosure is directed to an acoustic inspection system configured to generate an estimate of an a priori accuracy of a measurement, the acoustic inspection system comprising: a display device: a probe assembly to be positioned on an object under test: and a processor configured to perform operations including: generating, using a plurality of acoustic parameters, a model representing an acoustic signal to be received by the probe assembly of the acoustic inspection system: determining, using the plurality of acoustic parameters, a lower bound on an indicium of dispersion of the measurement: determining the a priori estimate using the determined lower bound on the indicium of dispersion of the measurement; and displaying, on the display device, the determined a priori estimate of the accuracy of the acoustic inspection system.

In an aspect, this disclosure is directed to a machine-readable medium including instructions that, when executed by at least one processor, cause a system to: generate, using a plurality of acoustic parameters, a model representing an acoustic signal to be received by a probe assembly of an acoustic inspection system: determine, using the plurality of acoustic parameters, a lower bound on an indicium of dispersion of the measurement: determine an estimate of an a priori accuracy of a measurement using the determined lower bound on the indicium of dispersion of the measurement: and display, on a display device, the determined a priori estimate of the accuracy of the acoustic inspection system.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates generally an example of an acoustic inspection system, such as can be used to perform at least a portion one or more techniques as shown and described in this disclosure.

FIG. 2 is a flow diagram of an example of a method of generating an estimate of an a priori accuracy of a measurement of an acoustic inspection system configured to measure a parameter of an object under test, using various techniques of this disclosure.

FIG. 3 is a flow diagram of an example of a method of determining a lower bound on an indicium of dispersion of a measurement.

FIG. 4 depicts an example of an experimentally-obtained ultrasound image.

FIG. 5 depicts an example of an experimentally-obtained ultrasound image displayed with an a priori estimate of the accuracy of the acoustic inspection system, such as of a thickness measurement of the ultrasound inspection system.

FIG. 6 depicts an example of an experimentally-obtained ultrasound image displayed with an a priori estimate of the accuracy of the acoustic inspection system, such as of a thickness measurement of the ultrasound inspection system.

FIG. 7 is a flow diagram of an example of a method of generating an estimate of an a priori accuracy of a measurement of an acoustic inspection system configured to measure a parameter of an object under test, using various techniques of this disclosure.

FIG. 8 illustrates a block diagram of an example comprising a machine upon which any one or more of the techniques (e.g., methodologies) discussed herein may be performed.

### DETAILED DESCRIPTION

Acoustic testing, such as ultrasound-based inspection, can include focusing or beam-forming techniques to aid in construction of data plots or images representing a region of interest within the test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures.

In another approach, a Total Focusing Method (TFM) technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array. Generally, imaging is performed by a probe or structure under test are moved relative to each other. For example, for applications involving acoustic inspection of composite or steel structures, a probe assembly or carriage can be moved along a surface of the structure under test.

The present inventor has recognized that because existing acoustic inspection systems do not determine a measurement accuracy, users are unable to assess how close the measurements of the acoustic inspection systems are to their true value. The present inventor has recognized, among other things, the desirability of providing to a user an estimate of an a priori accuracy of a measurement, such as a thickness of an object under test, using an acoustic inspection system. Using various techniques of this disclosure, an acoustic inspection system, such as an ultrasound inspection system, can determine an estimate of an a priori accuracy of a measurement using a determined lower bound on an indicium of dispersion of the measurement, such as a variance, and then display the determined estimate of the a priori accuracy to the user.

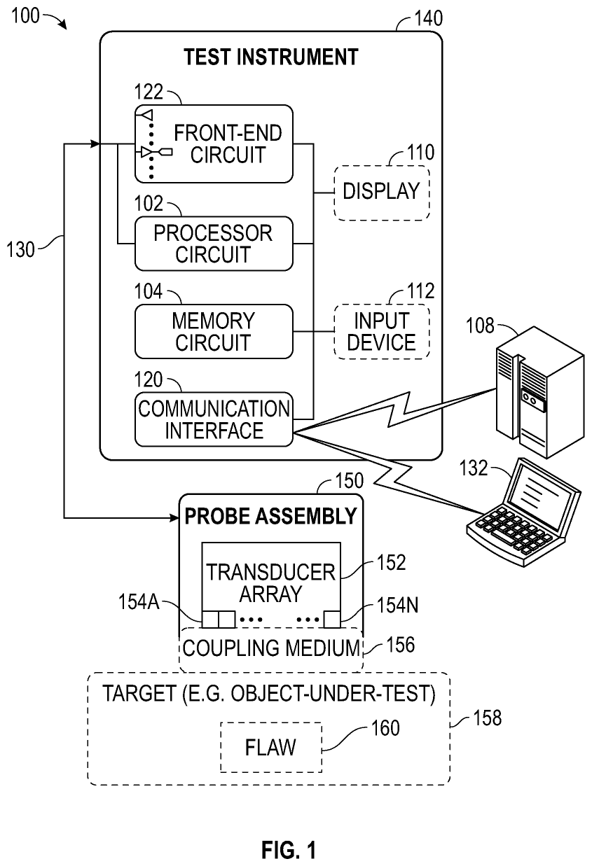

FIG. 1 illustrates generally an example of an acoustic inspection system 100, such as can be used to perform at least a portion one or more techniques as shown and described in this disclosure. The inspection system 100 can include a test instrument 140, such as a hand-held or portable assembly. The test instrument 140 can be electrically coupled to a probe assembly, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies 150. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single or multiple probe assemblies 150 for pitch/catch inspection modes. Similarly, a test protocol can be performed using coordination between multiple test instruments 140, such as in response to an overall test scheme established from a master test instrument 140, or established by another remote system such as a compute facility 108 or general purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

By using various techniques of this disclosure, an acoustic inspection system, such as the acoustic inspection system 100 of FIG. 1, can determine an estimate of an a priori accuracy of a measurement using a determined lower bound on an indicium of dispersion, such as a variance, and then display the determined estimate of the a priori accuracy to the user.

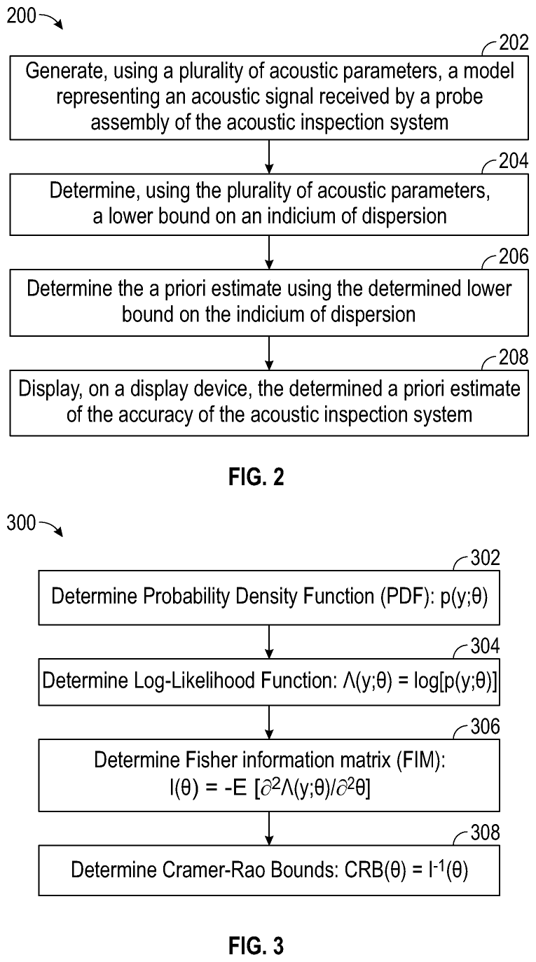

FIG. 2 is a flow diagram of an example of a method 200 of generating an estimate of an a priori accuracy of a measurement of an acoustic inspection system configured to measure a parameter of an object under test, using various techniques of this disclosure. The method is represented as a set of blocks that describe operations 202-208 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 2. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At block 202, the method 200 can include generating, using a plurality of acoustic parameters, a model representing an acoustic signal to be received by a probe assembly of the acoustic inspection system, such as the probe assembly 150 of the acoustic inspection system 100 of FIG. 1. In some examples, the model of the ultrasound signal includes a mathematical model of an A-scan ultrasound signal. Accuracy is a function of various acoustic parameters of the acoustic inspection system 100.

The acoustic inspection system 100 can determine a time-of-flight (TOF) t₀ that can be used to determine a thickness d₀ of the material under test, where d₀=c*(t₀/2). The actual measurement [symbol] is given as [symbol] =X±3σ_{d}, where X is the true value of the thickness and σ_{d} is the standard deviation. The standard deviation σ_{d}, which is an example of an indicium of dispersion of a measurement, is a function of various acoustic parameters of the probe, the material under test, and the instrumentation. The standard deviation σ_{d} is given as σ_{d}=f(c,β,Fₛ,Fₚ,E,σₙ²), where c is velocity of sound in a given material, β is related to the probe bandwidth, Fₛ is the sampling frequency, Fₚ is the central frequency of the probe, E is the maximum amplitude of the signal generated by the acoustic inspection system and applied to the material under test, and σₙ² is the noise power. These acoustic parameters are a prior known (or can be determined by simulations and measurements).

A model s(k) representing an acoustic signal y(k) is given by Equation 1:

$$s ( k ) = E ( k ) \cdot cos ϕ ( k ) , \qquad Equation 1$$

where E(k) is the amplitude of the acoustic signal y(k). The amplitude E(k) is given by Equation 2:

$$E ( k ) = E \cdot exp \{ - {[ β x ( k ) ]}^{2} \} , \qquad Equation 2$$

The variable x(k) represents the time-base and is given by Equation 3:

$$x ( k ) = k {T}_{s} - {t}_{0} , \qquad Equation 3$$

where k represents the sample index, Tₛ represents the sample period, and t₀ represents the time where the amplitude E(k) reaches its maximum value. It should be noted that

$$k {T}_{s} = \frac{k}{{F}_{s}} ,$$

where Fₛ is the sampling frequency.

The phase ϕ(k) in Equation 1 is given by Equation 4:

$$ϕ ( k ) = 2 π {F}_{p} x ( k ) + {ϕ}_{0} , \qquad Equation 4$$

where Fₚ is the probe central frequency and ϕ₀ is the initial phase. The signal-to-noise ratio (SNR) is given by Equation 5:

$$SNR = \frac{{E}^{2}}{2 \cdot {σ}_{n}^{2}} \qquad Equation 5$$

By using various acoustic parameters and Equations 1-5, a processor, such as the processor circuit 102 of FIG. 1, can generate a model s(k) representing an acoustic signal y(k) to be received by a probe assembly of the acoustic inspection system, such as the probe assembly 150 of the acoustic inspection system 100 of FIG. 1, where y(k)=s(k)+n(k), with n(k) representing a noise component.

In some examples, the method 200 can optionally include receiving an input representing a type of material of the object under test. For example, a use can input that the object under test includes steel, aluminum, or some other material.

At block 204, the method 200 can include determining, using the plurality of acoustic parameters, a lower bound on an indicium of dispersion of a measurement. The indicium of dispersion can include a variance, a standard deviation, and the like. For example, the method 200 can include determining, using the plurality of acoustic parameters, a lower bound on a variance estimate. In some examples, determining, using the plurality of acoustic parameters, the lower bound on the variance estimate includes determining a Cramer-Rao lower bound, which is shown and described below with respect to FIG. 3. The Cramer-Rao lower bound is given by Equation 6:

$$CRB ( θ ) = {σ}_{d}^{2} = \frac{1}{4} \cdot \sqrt{\frac{π}{2}} \cdot \frac{β}{{F}_{p}^{2}} \cdot {c}^{2} \cdot \frac{1}{{F}_{s}} \cdot \frac{1}{SNR} \qquad Equation 6$$

At block 206, the method 200 can include determining the a priori estimate using the determined lower bound on the indicium of dispersion of the measurement. For example, when the lower bound on the variance estimate includes a Cramer-Rao lower bound, the method can include determining a square root of the determined Cramer-Rao lower bound σ_{d}², such as to determine the standard deviation σ_{d}.

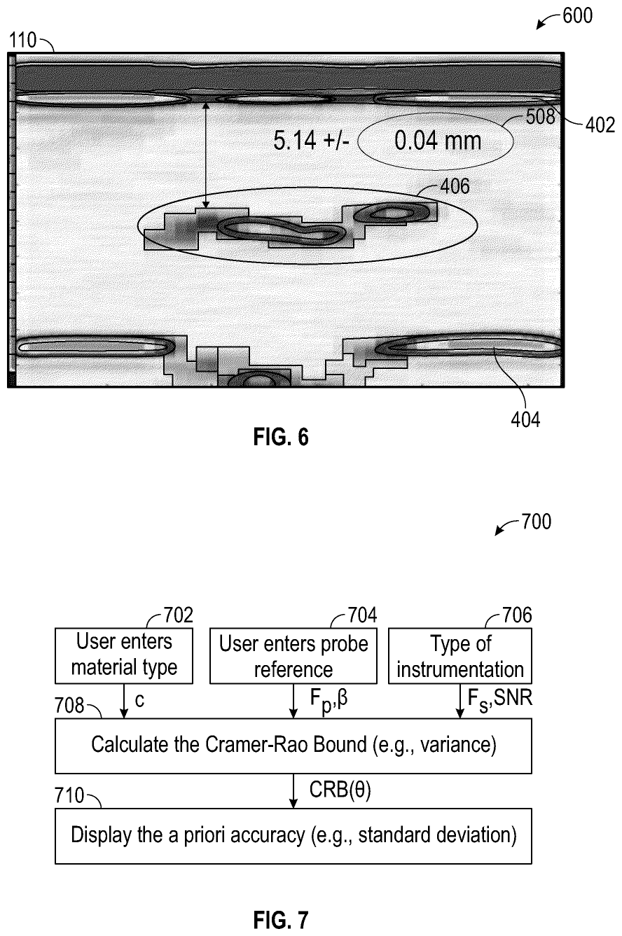

At block 208, the method 200 can include displaying, on a display device, the determined a priori estimate of the accuracy of the acoustic inspection system, such as of a thickness measurement of the ultrasound inspection system. For example, the acoustic inspection system 100 of FIG. 1 can display the determined a priori estimate of the accuracy on the display 110, such as shown in FIG. 5. In some examples, the method 200 can include displaying an image of the object under test, such as a TFM image or a B-scan image, along with the determined a priori estimation, such as shown in FIG. 6.

FIG. 3 is a flow diagram of an example of a method 300 of determining a lower bound on an indicium of dispersion of a measurement. More particularly, the method 300 depicts determining a Cramer-Rao bound. The method is represented as a set of blocks that describe operations 302-308 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 3. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At block 302, the method 300 can include determining a probability density function (PDF) p(y; θ), where θrepresents the thickness d₀ of the material under test. The PDF p(y; θ) is given by Equation 7:

$$p ( y ; θ ) = {\prod }_{k = 1}^{N} \frac{1}{\sqrt{2 π {σ}^{2}}} \cdot exp \{ - \frac{1}{2 {σ}^{2}} \cdot {[ y ( k ) - s ( k ) ]}^{2} \} \qquad Equation 7$$

At block 304, the method 300 can include determining a log-likelihood function Λ(y; θ) using the PDF p(y; θ). The log-likelihood function Λ(y; θ) is given by Equation 8:

$$Λ ( y ; θ ) = log [ p ( y ; θ ) ] \qquad Equation 8$$

At block 306, the method 300 can include determining a Fisher Information Matrix (FIM) I(θ) using the log-likelihood function. The FIM is given by Equation 9:

$$I ( θ ) = - E [ \frac{{\partial }^{2} Λ ( y ; θ )}{{\partial }^{2} θ} ] \qquad Equation 9$$

At block 308, the method 300 can include determining the Cramer-Rao Bounds CRB(θ). The Cramer-Rao Bound CRB(θ) is given by Equation 10:

$$CRB ( θ ) = {I}^{- 1} ( θ ) \qquad Equation 10$$

In this example, the Cramer-Rao Bound CRB(θ), which is the lower bound on a variance estimate, is given by Equation 11:

$$CRB ( θ ) = {σ}_{d}^{2} = \frac{1}{4} \cdot \sqrt{\frac{π}{2}} \cdot \frac{β}{{F}_{p}^{2}} \cdot {c}^{2} \cdot \frac{1}{{F}_{s}} \cdot \frac{1}{SNR} , \qquad Equation 11$$

where the signal-to-noise ratio SNR is given as Equation 12:

$$SNR = \frac{{E}^{2}}{2 \cdot {σ}_{n}^{2}} \qquad Equation 12$$

The standard deviation can be determined, which is the square root of Equation 10, given below by Equation 13:

$${σ}_{d} = \frac{1}{2} \cdot \frac{1}{{F}_{p}} \cdot c \cdot \frac{{σ}_{n}}{E} \cdot \sqrt{\frac{\sqrt{\frac{π}{2}} β}{{F}_{s}}} \qquad Equation 13$$

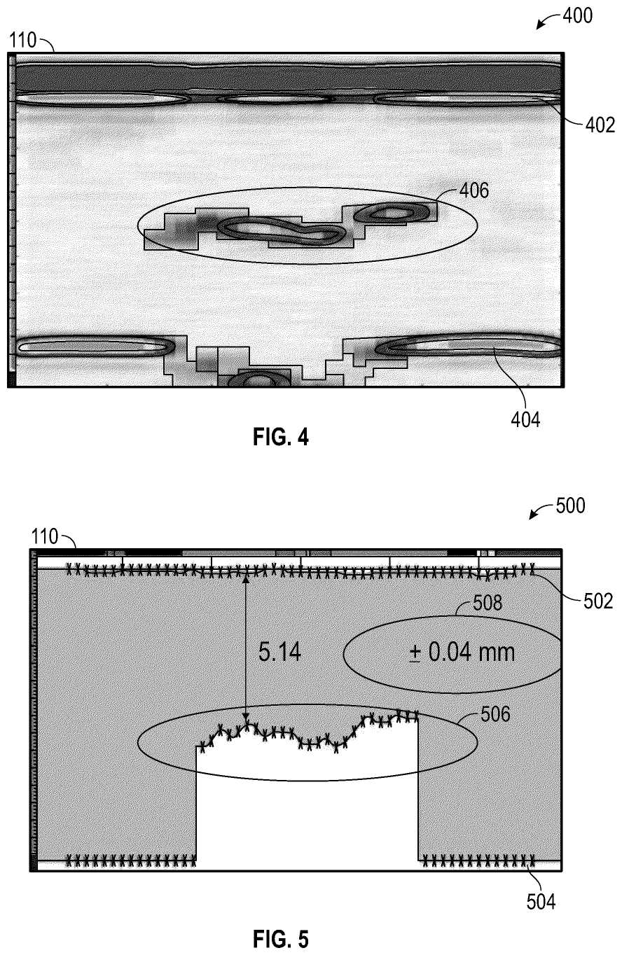

FIG. 4 depicts an example of an experimentally-obtained ultrasound image. The ultrasound image 400 is an example of an acquired B-scan image of the object under test that can be displayed on an acoustic inspection system, such as on a display 110 of acoustic inspection system 100 of FIG. 1. The ultrasound image 400 includes a front wall portion 402 and back wall portion 404, such as acquired using a linear probe with 64 elements and a probe central frequency equal to 7.5 megahertz (MHz). The front wall portion 402 and the back wall portion 404 provide an indication of thickness of the specimen. Examples of flaws in the material under test are depicted at 406.

FIG. 5 depicts an example of an experimentally-obtained ultrasound image displayed with an a priori estimate of the accuracy of the acoustic inspection system, such as of a thickness measurement of the ultrasound inspection system. The ultrasound image 500 includes a front wall portion 502 and back wall portion 504, such as acquired using a linear probe with 64 elements and a probe central frequency equal to 7.5 MHz. The front wall portion 502 and the back wall portion 504 provide an indication of thickness of the specimen. Examples of flaws in the material under test are depicted at 506. The image 500 of FIG. 5 includes the a priori estimate 508 of the accuracy of the measurement, shown as a non-limiting example of an accuracy of +/−0.04 mm of a thickness measurement of 5.14 millimeters (mm).

FIG. 6 depicts an example of an experimentally-obtained ultrasound image displayed with an a priori estimate of the accuracy of the acoustic inspection system, such as of a thickness measurement of the ultrasound inspection system. The image 600 of FIG. 6 combines features of FIG. 4 and FIG. 5. The ultrasound image 600 is an example of an acquired B-scan image of the object under test that can be displayed on an acoustic inspection system, such as on a display 110 of acoustic inspection system 100 of FIG. 1, along with the a priori estimate of the accuracy of the acoustic inspection system. The ultrasound image 600 includes a front wall portion 502 and back wall portion 504, such as acquired using a linear probe with 64 elements and a probe central frequency equal to 7.5 MHz. The front wall portion 502 and the back wall portion 504 provide an indication of thickness of the specimen. Examples of flaws in the material under test are depicted at 506. The image 600 of FIG. 6 includes the a prior estimate 508 of the accuracy of the measurement, shown as a non-limiting example of an accuracy of +/−0.04 mm of a thickness measurement of 5.14 mm.

FIG. 7 is a flow diagram of an example of a method 700 of generating an estimate of an a priori accuracy of a measurement of an acoustic inspection system configured to measure a parameter of an object under test, using various techniques of this disclosure. The method is represented as a set of blocks that describe operations 702-710 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 7. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At block 702, the method 700 includes a user entering the type of material, e.g., steel, aluminum, etc., which is used to determine the velocity c of sound in a given material.

At block 704, the method 700 includes a user entering the probe reference to indicate the characteristics of the probe, including β, which is related to the probe bandwidth, and Fₚ, which is the central frequency of the probe.

At block 706, the method 700 includes determining the type of instrumentation to indicate characteristics of the acoustic inspection system, including Fₛ, which is the sampling frequency, and the SNR.

At block 708, the method 700 includes calculating the Cramer-Rao bound, such as the variance. For example, the processor circuit 102 of the acoustic inspection system 100 of FIG. 1 can be used to calculate the Cramer-Rao bound, such as described above, e.g., with respect to FIG. 3.

At block 710, the method 700 includes displaying the a priori accuracy of the measurement of the acoustic inspection system. For example, the display 110 of FIG. 1 can display the a priori accuracy.

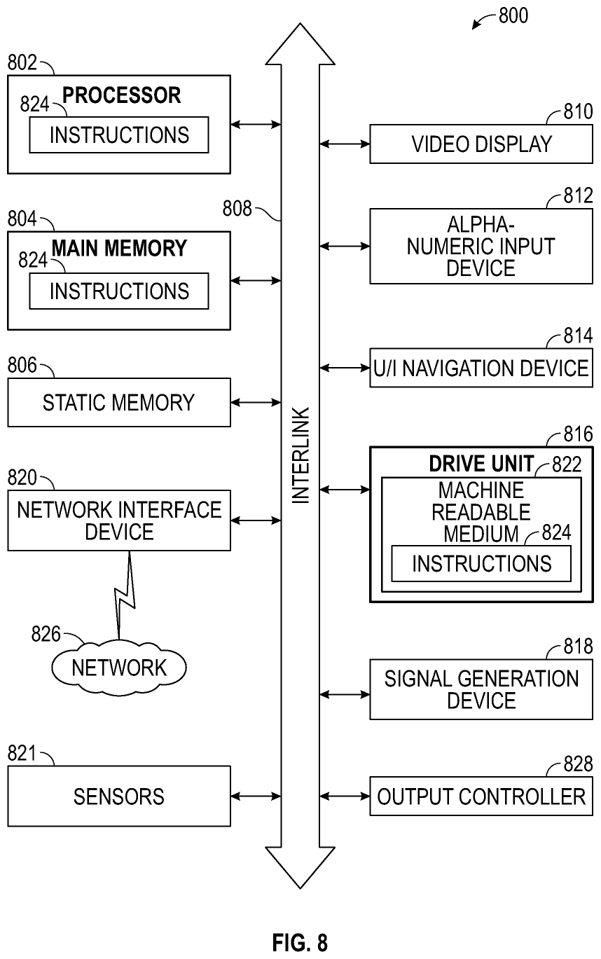

FIG. 8 illustrates a block diagram of an example comprising a machine 800 upon which any one or more of the techniques (e.g., methodologies) discussed herein may be performed. In various examples, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 700 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 730. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 716, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 808 may constitute machine-readable media.

While the machine-readable medium 822 is illustrated as a single medium, the term “machine-readable medium” may include a single medium or multiple media (e.g., a centralized or distributed database, and/or associated caches and servers) configured to store the one or more instructions 824.

The term “machine-readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices: magnetic or other phase-change or state-change memory circuits: magnetic disks, such as internal hard disks and removable disks: magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks such as conforming to one or more standards such as a 4G standard or Long Term Evolution (LTE)), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others). In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### VARIOUS NOTES

Each of the non-limiting aspects described herein can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

The claimed invention is:

1. A computer-implemented method of generating an estimate of an a priori accuracy of a measurement of an acoustic inspection system configured to measure a parameter of an object under test, the computer-implemented method comprising:
generating, using a plurality of acoustic parameters, a model representing an acoustic signal to be received by a probe assembly of the acoustic inspection system:
determining, using the plurality of acoustic parameters, a lower bound on an indicium of dispersion of the measurement:
determining the a priori estimate using the determined lower bound on the indicium of dispersion of the measurement; and
displaying, on a display device, the determined a priori estimate of the accuracy of the acoustic inspection system.

2. The computer-implemented method of claim 1, wherein determining, using the plurality of acoustic parameters, the lower bound on the indicium of dispersion of the measurement includes:
determining, using the plurality of acoustic parameters, a lower bound on a variance estimate.

3. The computer-implemented method of claim 2, wherein determining, using the plurality of acoustic parameters, the lower bound on the variance estimate includes:
determining, using the plurality of acoustic parameters, a Cramer-Rao lower bound.

4. The computer-implemented method of claim 3, wherein determining the a priori estimate using the determined lower bound on the indicium of dispersion of the measurement includes:
determining a square root of the determined Cramer-Rao lower bound.

5. The computer-implemented method of claim 1, further comprising:
receiving an input representing a type of material of the object under test.

6. The computer-implemented method of claim 1, further comprising:
displaying an image of the object under test along with the determined a priori estimation.

7. The computer-implemented method of claim 1, wherein displaying, on the display device, the determined a priori estimation of the accuracy of the acoustic inspection system includes:
displaying, on the display device, the determined a priori estimation of the accuracy of a thickness measurement of the acoustic inspection system.

8. The computer-implemented method of claim 1, wherein the model representing the acoustic signal includes a model of an A-scan ultrasound signal.

9. An acoustic inspection system configured to generate an estimate of an a priori accuracy of a measurement, the acoustic inspection system comprising:
a display device;
a probe assembly to be positioned on an object under test; and
a processor configured to perform operations including:
generating, using a plurality of acoustic parameters, a model representing an acoustic signal to be received by the probe assembly of the acoustic inspection system;
determining, using the plurality of acoustic parameters, a lower bound on an indicium of dispersion of the measurement;
determining the a priori estimate using the determined lower bound on the indicium of dispersion of the measurement; and
displaying, on the display device, the determined a priori estimate of the accuracy of the acoustic inspection system.

10. The acoustic inspection system of claim 9, wherein determining, using the plurality of acoustic parameters, the lower bound on the indicium of dispersion of the measurement includes:
determining, using the plurality of acoustic parameters, a lower bound on a variance estimate.

11. The acoustic inspection system of claim 10, wherein determining, using the plurality of acoustic parameters, the lower bound on the variance estimate includes:
determining, using the plurality of acoustic parameters, a Cramer-Rao lower bound.

12. The acoustic inspection system of claim 11, wherein determining the a priori estimate using the determined lower bound on the indicium of dispersion of the measurement includes:
determining a square root of the determined Cramer-Rao lower bound.

13. The acoustic inspection system of claim 9, further comprising:
receiving an input representing a type of material of the object under test.

14. The acoustic inspection system of claim 9, further comprising:
displaying an image of the object under test along with the determined a priori estimation.

15. The acoustic inspection system of claim 9, wherein displaying, on the display device, the determined a priori estimation of the accuracy of the acoustic inspection system includes:
displaying, on the display device, the determined a priori estimation of the accuracy of a thickness measurement of the acoustic inspection system.

16. The acoustic inspection system of claim 9, wherein the model representing the acoustic signal includes a model of an A-scan ultrasound signal.

17. A machine-readable medium including instructions that, when executed by at least one processor, cause a system to:
generate, using a plurality of acoustic parameters, a model representing an acoustic signal to be received by a probe assembly of an acoustic inspection system;
determine, using the plurality of acoustic parameters, a lower bound on an indicium of dispersion of the measurement;
determine an estimate of an a priori accuracy of a measurement using the determined lower bound on the indicium of dispersion of the measurement; and
display, on a display device, the determined a priori estimate of the accuracy of the acoustic inspection system.

18. The machine-readable medium of claim 17, wherein the instructions that, when executed by at least one processor, cause the system to determine, using the plurality of acoustic parameters, the lower bound on the indicium of dispersion of the measurement cause the system to:
determine, using the plurality of acoustic parameters, a lower bound on a variance estimate.

19. The machine-readable medium of claim 18, wherein the instructions that, when executed by at least one processor, cause the system to determine, using the plurality of acoustic parameters, the lower bound on the variance estimate cause the system to:
determine, using the plurality of acoustic parameters, a Cramer-Rao lower bound.

20. The machine-readable medium of claim 19, wherein the instructions that, when executed by at least one processor, cause the system to determine the a priori estimate using the determined lower bound on the indicium of dispersion of the measurement includes:
determining a square root of the determined Cramer-Rao lower bound.

21. The machine-readable medium of claim 17, comprising the instructions that, when executed by at least one processor, cause the system to:
display an image of an object under test along with the determined a priori estimation.
